(19) United States
(12) Patent Application Publication
(10) Pub. No.: US 2007/0222779 A1
(43) Pub. Date: Sep. 27, 2007

(54) System, method, and apparatus for content delivery format control

(75) Inventors: Steven S. Fastert, Chelmsford, MA (US); Bhavin Patel, Jamaica Plain, MA (US); Samuel J. MacMullan, Carlisle, MA (US); Tandhoni S. Rao, Ashland, MA (US)

Correspondence Address: FIALA & WEAVER, P.L.L.C.;C/O INTELLEVATE, P.O. BOX 52050, MINNEAPOLIS, MN, 55402, US

(73) Assignee: Radiospire Networks, Inc., Concord, MA (US)

(21) Appl. No.: 11/642,887

(22) Filed: Dec. 21, 2006

Related U.S. Application Data
(60) Provisional application No. 60/785,269, filed on Mar. 24, 2006.

(51) Int. Cl. G06T 1/00

(52) U.S. Cl. 345/418

(57) ABSTRACT

The present invention is directed to a system, method and apparatus for implementing a content delivery system that includes at least one bi-directional distribution system between a generalized content source and a generalized content sink. The bi-directional distribution system enables the content source and the content sink to coordinate with each other to determine the capabilities of the content distribution system, the content source, and the content sink, and to best control the content format accordingly.

### CROSS-REFERENCE TO RELATED APPLICATIONS

The present application claims the benefit of U.S. Provisional Patent Application No. 60/785,269 filed on Mar. 24, 2006, which is incorporated herein by reference.

### BACKGROUND OF THE INVENTION

1. Field of the Invention

The present invention is generally related to content delivery systems. More particularly, the present invention is directed to a system, method and apparatus that coordinate between a content source and a content sink to ensure that content is distributed using a format most appropriate given the content distribution system, content source, and content sink capabilities.

2. Background

Today, a multitude of different content distribution systems are employed in analog and digital content delivery systems. In many of these delivery systems, the distribution system between the content source and the content sink is unidirectional (e.g., terrestrial TV and radio broadcasts). Accordingly, the content source has no mechanism to determine the quality of the content distribution system and/or “display” capabilities of the content sink(s). As a result, the content source relies upon the adoption of and compliance with universally agreed upon standards to ensure the proper transmission and display of content at the sink(s).

However, in a certain subset of the delivery systems employed for analog and/or digital content, the distribution system between the content source and the content sink is bi-directional (e.g., cable TV infrastructure, cellular infrastructure, satellite TV and radio broadcasts, Internet streaming). Further, the content source and the content sink can be augmented to include additional processing circuitry and one or more transceivers, either embedded in or located externally to the source/sink. Accordingly, it may be possible to use a bi-directional distribution system to allow the content source and the content sink to share information regarding their capabilities, and for one or both to collect information regarding the quality of the content distribution system. The content source and sink can then cooperate to ensure that content is delivered using a format most appropriate given the content distribution system, source, and sink capabilities.

For example, in the case of Internet streaming content delivery systems, users already have the ability to manually set both the connection speed (e.g. dial-up, DSL, cable modem, etc.) and image size (e.g. 320×240, 640×480, etc.) when initiating streaming. Using the bi-directional nature of the Internet distribution system and a simple set of queries, the content source may determine the connection speed and/or display capabilities of the attached PC (content sink), and set transmission and display parameters automatically, either statically or dynamically.

Other examples of this type of bi-directionally enabled content distribution systems are HDMI and DVI cables. These content distribution systems are used to deliver high speed, uncompressed audio and video from PCs, DVD, STBs (Set-top Boxes), etc. to computer monitors, digital TVs, projectors, speakers, etc. Both HDMI and DVI cables include a bi-directional control channel, in addition to a uni-directional content channel.

However, given the wide range of content distribution systems, it is unlikely that a standard will emerge governing the ability of a content sink and source to share capability information and/or to coordinate to determine the capabilities of the content distribution system.

What are needed therefore are a method, system, and apparatus that enable a content source and/or a content sink to determine the capabilities of at least one of the content distribution system, the content sink, and the content source. Further, the method, system, and apparatus should enable a content source and a content sink, connected via at least one bi-directional wired or wireless distribution system, to coordinate with each other based on gathered capability information to perform operations resulting in optimal content formatting for transmission to and display at the content sink. Further, the method, system, and apparatus should be applicable to wired, optical and/or wireless distribution systems connecting a wide range of content sources and content sinks and carrying various types of analog/digital content.

### BRIEF SUMMARY OF THE INVENTION

The present invention is directed to a system, method and apparatus for implementing a content delivery system that includes at least one bi-directional distribution system between a content source and a content sink. The system, method, and apparatus enable the content sink and/or the content source to determine the capabilities of at least one of the content distribution system, the content sink, and the content source, and to coordinate accordingly with each other to ensure the most appropriate content format. In an embodiment, after the content source and/or content sink determine these capabilities, the bi-directional distribution system is used to enable the source and sink to coordinate to ensure that content is delivered using a format most appropriate given the capabilities of the content distribution system, the content source, and the content sink.

Embodiments of the present invention are applicable to short distance distribution systems such as HDMI/DVI cables, UWB, and Bluetooth, medium distance distribution systems such as LAN, WiFi, and 802.11n, and long distance distribution systems such as telephone/DSL, cable, cellular, and satellite.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a generalized content delivery system.

FIG. 2 is a diagram that illustrates a process that statically formats content for distribution in a content delivery system.

FIG. 3 is a diagram that illustrates a process that dynamically formats content for distribution in a content delivery system.

FIG. 4 illustrates a conventional high-definition content delivery system.

FIG. 5 illustrates a wireless high-definition content delivery system that can be used to replace the system of FIG. 4.

FIG. 6 illustrates an embodiment of the system of FIG. 5 wherein capabilities of the content sink are cached at the content source.

FIG. 7 is a diagram that illustrates a process for statically formatting content for distribution in the embodiment of FIG. 6.

FIG. 8 illustrates a basic EDID (Extended Display Identification Data) structure.

FIG. 9 illustrates a Consumer Electronics Association (CEA) extension to the basic EDID structure of FIG. 8.

FIG. 10 is a diagram that illustrates a process for dynamically formatting content for distribution in the embodiment of FIG. 6.

FIG. 11 illustrates an embodiment of the system of FIG. 5 wherein the content sink modifies the reporting of its capabilities based on knowledge of the content distribution system capabilities.

FIG. 12 is a diagram that illustrates a process for dynamically formatting content for distribution in the embodiment of FIG. 11.

FIG. 13 is a diagram that illustrates a process for dynamically controlling content in a content delivery system.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

The present invention is directed to a system, method and apparatus for implementing a content delivery system that includes at least one bi-directional distribution system between a content source and a content sink. The system, method, and apparatus enable the content sink and/or content source to determine the capabilities of at least one of the content distribution system, the content sink, and the content source. Further, the system, method, and apparatus enable the content sink and source to accordingly coordinate with each other to ensure the most appropriate content format. In an embodiment, after the content source and/or sink determine these capabilities, the bi-directional distribution system is used to enable the source and the sink to coordinate to ensure that content is distributed using a format most appropriate given the capabilities of the content distribution system, the content source, and the content sink.

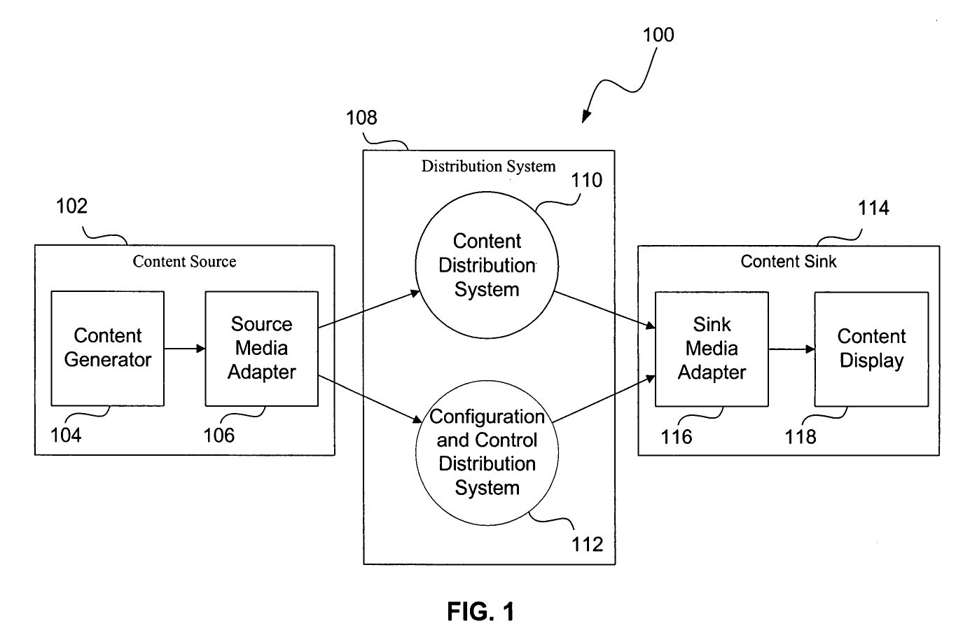

FIG. 1 illustrates a generalized content delivery system 100. Generalized content delivery system 100 includes a content source 102, a distribution system 108, and a content sink 114. Content source 102 includes a content generator 104, which is the originator of content, and a source media adapter 106, which conditions the output of content generator 104 for transfer over distribution system 108 to content sink 114. Content sink 114 includes a sink media adapter 116 and a content display 118. Sink media adapter 116 collects signals received over distribution system 108, processes the received signals to determine their content, and formats the content for transfer to content display 118. Content display 118 is the receiver of content. Source media adapter 106 and sink media adapter 116 may contain additional processing circuitry such as, for example, configuration and control circuitry.

Distribution system 108 may include one or more wired and/or wireless links that connect content source 102 and content sink 114. As shown in FIG. 1, distribution system 108 includes a content distribution system 110 and a configuration and control distribution system 112, which respectively transfer content and configuration and control information from content source 102 to content sink 110. As used herein, content refers to data content including multimedia content, for example.

Typically, transmission protocols govern the transmission of content over content distribution system 110. Further, links within distribution system 108 may be unidirectional or bidirectional. Unidirectional links support one-way data transfer. Bidirectional links support two-way data transfer.

Accordingly, based on the type of distribution system that connects them, content source 102 and content sink 114 may each include means for transmitting and/or means for receiving over distribution system 108. For example, when the two are connected by unidirectional links only, content source 102 may only include a means for transmitting while content sink 114 may only include a means for receiving.

It is noted that content delivery system 100 of FIG. 1 is illustrated as having a single content source and a single content sink. A generalized content delivery system, according to the present invention, is not limited to such illustration, and may include one or more content sources and/or one or more content sinks connected by the distribution system.

### B. Content Format Control

Content format control in a generic content delivery system is now presented. First, a “static” approach is described, in which the capabilities are only assessed once and are then used by the source to determine the best content transmit format. A “dynamic” approach is then presented, in which the source receives capability updates and uses the updates to determine whether the content transmit format should be modified. In both the static and the dynamic approaches, the content source is responsible for adjusting the content format based on the distribution system capabilities. In an alternative dynamic approach, the content sink “filters” the capabilities information that it provides to the content source, to reflect the distribution system capabilities. In this case, the content sink is responsible for assessing the quality of the content distribution system and reflecting this assessment in the selection of candidate content formats.

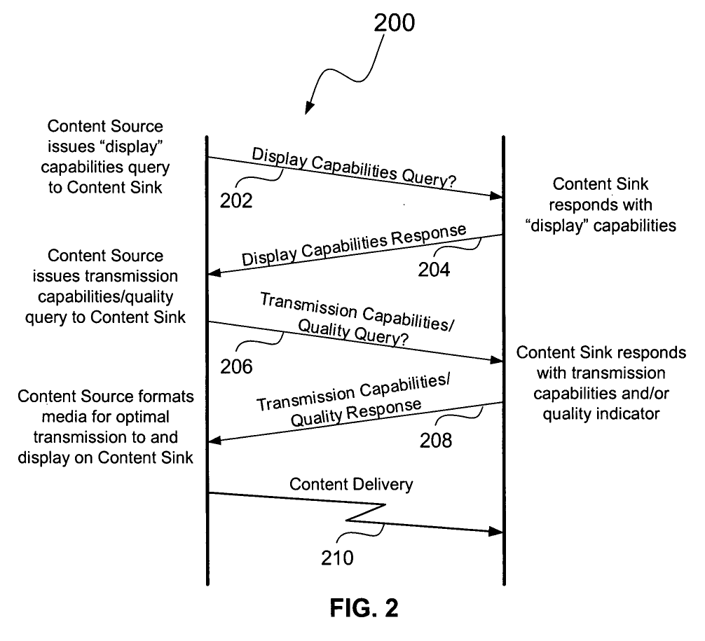

FIG. 2 is a diagram that illustrates a process 200 that enables a content source to statically control the content format in a content delivery system, based on capabilities information provided by a content sink. Process 200 will be described with reference to the generalized content delivery system 100 of FIG. 1. For ease of illustration, the process is described with reference to the content sink having display capabilities.

Prior to the first step of the process 200, content source 102 and content sink 114 have both been powered up and may have communicated initial signals asserting their availability for content transfer. Subsequently, in step 202, content source 102 issues a display capabilities query to content sink 114. The display capabilities query is transferred from content source 102 to content sink 114 over configuration and control distribution system 112. Upon receiving the query, content sink 114 responds, in step 204, with a display capabilities response to content source 102. The display capabilities response includes several parameters that characterize the display capabilities of content sink 114. Such parameters may include, for example, the maximum visible display size, the maximum display resolution, and the picture aspect ratio of content sink 114.

Upon receiving the display capabilities response from content sink 114, content source 102 issues, in step 206, a transmission capabilities/quality query to content sink 114. The purpose of the transmission capabilities/quality query is to determine the capacity and quality of content distribution system 110 that connects content source 102 and content sink 114. By doing so, content source 102 may determine, among other things, the most appropriate content transfer rate to content sink 114. In an embodiment, a user of content sink 114 may statically define the transmission capabilities/link quality of content distribution system 110. For example, in the case of Internet streaming, a user may select the speed of the connection (e.g., dial-up, DSL, cable modem, etc.) linking its personal computer (content sink) to the Internet. In another embodiment, content sink 114 may dynamically measure the transmission capabilities/quality of content distribution system 110. This may include, for example, measuring the download speed, the upload speed, and the bit error rate of content distribution system 110.

In reply to the transmission capabilities query, content sink 114 responds, in step 208, with a transmission capabilities/quality response. The transmission capabilities/quality response includes one or more parameters that characterize the transmission capabilities/quality of content distribution system 110, as determined at content sink 114. It is noted that the parameters may differ according to the type of the content delivery system. For example, in a content delivery system having a wireless content distribution system, the bit error rate of the content distribution system may be a parameter of significance to include in the transmission capabilities/quality response. This however may not be as important in a wired content distribution system. Also, as described above, transmission capabilities parameters may be statically or dynamically determined at the content sink.

Upon receiving the transmission capabilities/quality response from content sink 114, content source 102 proceeds to determine the most appropriate content format according to the display capabilities and/or transmission capabilities learned from content sink 114, and initiates content delivery to content sink 114 in step 210. In an example, content source 102 having determined that content sink 114 supports high-definition television (HDTV) content proceeds to determine whether content distribution system 110 supports the data rate required for such content transfer. If so, content source 102 customizes content for HDTV display and initiates content transfer over content distribution system 110.

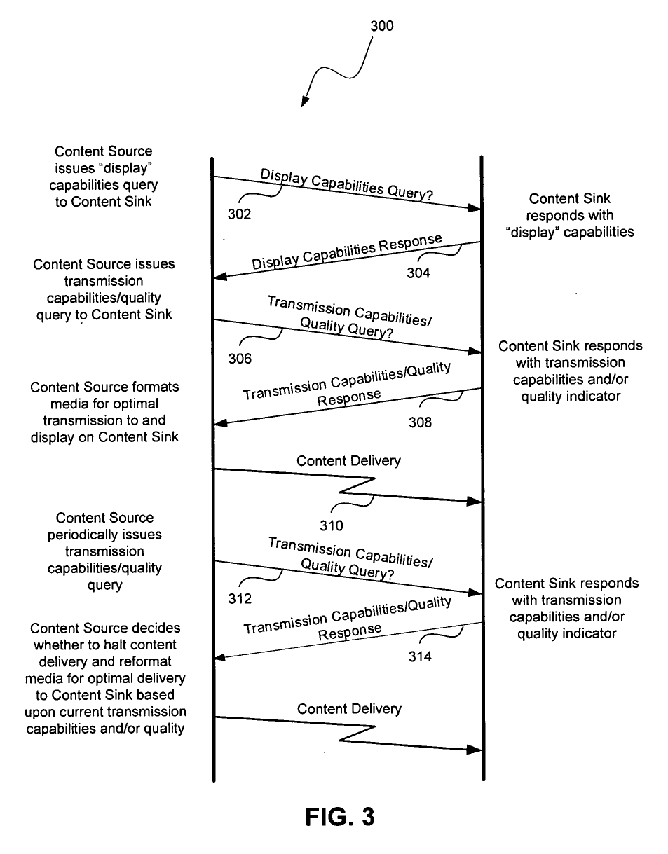

According to process 200, described above, the content format between content source 102 and content sink 114 is controlled according to the display capabilities of content sink 114 and/or the transmission capabilities of content distribution system 110. Note, however, that process 200 represents static content format control. In other words, the content format between content source 102 and content sink 114 continues for the duration of the delivery, according to the same display and/or transmission capabilities learned during the initial query/response exchanges. While this approach may be suitable for content distribution systems with no or minimal expected changes over the duration of content delivery, it is less suitable for distribution systems which manifest a tendency for frequent and unpredictable changes. In particular, due to the expected volatility of wireless communication links, this approach is not too suitable for content delivery systems having wireless content distribution systems. For such systems, dynamic approaches such as the one described below in FIG. 3 are preferred.

FIG. 3 is a diagram that illustrates a process 300 that dynamically controls the content format for delivery in a content delivery system. Process 300 will be described with reference to the generalized content delivery system 100 of FIG. 1.

Similar to process 200, process 300 includes initial query/response exchanges, as described above with respect to FIG. 2. The initial query/response exchanges, illustrated by steps 302, 304, 306, and 308 in FIG. 3, establish an initial content format for delivery between content source 102 and content sink 114. Subsequently, for the duration of content delivery, periodic or event-based exchanges are performed between content source 102 and content sink 114 to determine any changes in the transmission capabilities/quality of content distribution system 110. In an embodiment, these exchanges include periodic transmission capabilities/quality queries issued by content source 102 and corresponding transmission capabilities/quality responses by content sink 114, as illustrated in FIG. 3 by steps 312 and 314. In other embodiments, the exchanges are event-based and are performed in response to detected events in content distribution system 110.

Following each exchange, content source 102 determines whether to modify the content format according to any learned changes in the transmission capabilities/quality of content distribution system 110. For example, content source 102 may decide to lower the content delivery data rate when a deterioration in quality of content distribution system 110 is detected.

The exchanges, as described above, are performed for the duration of content delivery. In the case of periodic exchanges, the period at which these exchanges are performed may be a function of expected volatility of content distribution system 110. In other words, the period is determined based on the expected rate of change in transmission capabilities/quality of content distribution system 110. As would be appreciated by a person skilled in the art, several techniques exist for quantifying the volatility of a content distribution system. On the other hand, in the case of event-based exchanges, exchanges are performed in response to detected events in content distribution system 110. For example, the exchanges may be performed whenever changes in the transmission capabilities/quality of content distribution 110 are detected by content sink 114.

Accordingly, process 300 allows for dynamic control of the content format between content source 102 and content sink 114, according to the display capabilities of content sink 114 and/or the transmission capabilities/quality of content distribution system 110. This makes process 300 suitable for content delivery systems characterized by frequent and unpredictable content distribution system changes, such as content delivery systems having wireless content distribution systems.

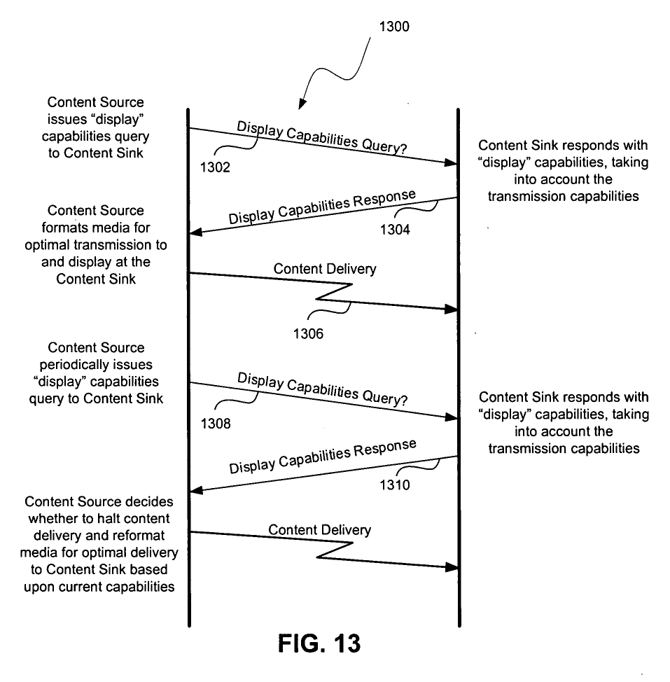

FIG. 13 is a diagram that illustrates a process 1300 that dynamically enables content format control in a content delivery system. Process 1300 will be described with reference to the generalized content delivery system 100 of FIG. 1. For ease of illustration, the process is described with reference to the content sink having display capabilities.

Similar to processes 200 and 300, prior to the first step of process 1300, content source 102 and content sink 114 have both been powered up and may have communicated initial signals asserting their availability for content transfer. Subsequently, again similar to processes 200 and 300, process 1300 begins in step 1302 with content source 102 issuing a display capabilities query to content sink 114. The display capabilities query is transferred from content source 102 to content sink 114 over configuration and control distribution system 112. In step 1304, upon receiving the display capabilities query, content sink 114 responds with a display capabilities response. However, unlike in processes 200 and 300, content sink 114 takes into account the transmission capabilities of the content distribution system when replying with the display capabilities in step 1304. In one embodiment, content sink 114 modifies its display capabilities so as to include only those that are supportable over the content distribution system based on the transmission capabilities of the content distribution system. In another embodiment, content sink 114 allows content formats that are not supportable by content display 118. In such case, the sink media adapter 116 must perform content format conversion (e.g., upscaling, downscaling) to enable proper display of content by content display 118.

Upon receiving the display capabilities response from content sink 114, content source 102 proceeds to determine the most appropriate content format according to the reported display capabilities and initiates content delivery to content sink 114 in step 1306. As in process 300, for the duration of content delivery, periodic or event-based exchanges are then performed between content source 102 and content sink 114 to determine any changes in the transmission capabilities/quality of content distribution system 110. In an embodiment, these exchanges include periodic display capabilities queries issued by content source 102 and corresponding display capabilities responses by content sink 114, as illustrated by FIG. 13 by steps 1308 and 1310. In generating the display capability response 1300, the content sink 114 takes into account the transmission capabilities/quality of content distribution system 110. In other embodiments, the exchanges are event-based and are performed in response to detected events in content distribution system 110.

Following each exchange, content source 102 determines whether to modify the content format according to any changes in the reported display capabilities. The exchanges, as described above, are performed for the duration of the content delivery and may be periodic or event-based.

Accordingly, process 1300 allows for dynamic control of the content format between content source 102 and content sink 114, according to the display capabilities reported by content sink 114, where the reported capabilities are adjusted by the content sink 114 based on the transmission capabilities/quality of content distribution system 110.

### C. Example Embodiments

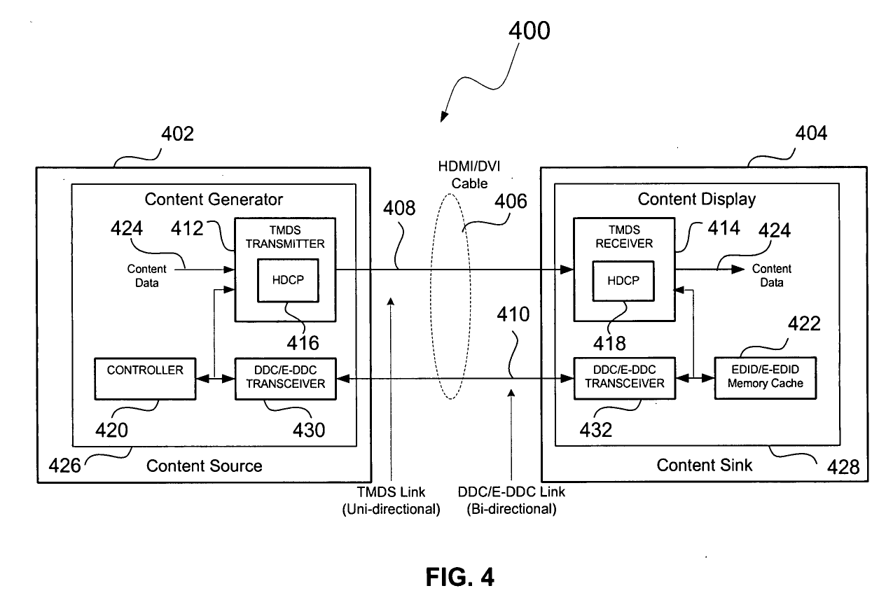

Exemplary embodiments according to the present invention will now be described with respect to high-definition content delivery systems. For the purpose of presentation, a conventional high-definition content delivery system 400 using an HDMI/DVI (High Definition Media Interface/Digital Video Interface) cable for content distribution will first be presented in FIG. 4.

Conventional content delivery system 400 includes a content source 402, a content sink 404, and a wired digital content distribution system 406. Note that system 400 does not require a source media adapter or a sink media adapter as the output of content generator 426 is suitable for direct transfer using distribution system 406 and content display 428 can directly accept input from distribution system 406.

Distribution system 406 comprises an HDMI or DVI cable. As is known in the art, a DVI cable supports uncompressed, real-time digital video. HDMI is based on the DVI model and supports both video and multi-channel audio. Typically, DVI-based interfaces employ the TMDS (Transition Minimized Differential Signaling) protocol for content transfer. Further, DVI-based interfaces implement the HDCP (High-bandwidth Digital Content Protection) protocol, which enables content encryption and source/sink authentication.

Distribution system 406 (an HDMI or DVI cable) includes a unidirectional TMDS link 408 and a bidirectional DDC/E-DDC (Display Data Channel/Enhanced DDC) link 410. TMDS link 408 serves for content distribution between content source 402 and content sink 404. DDC/E-DDC link 410 provides distribution of control and configuration information.

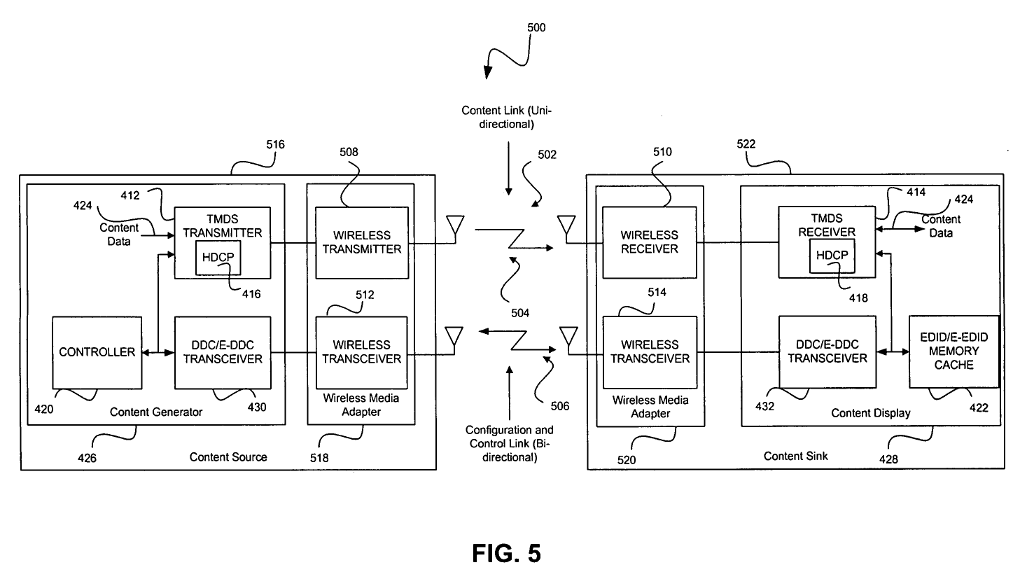

Content source 402 and content sink 404 respectively include a TMDS transmitter 412 and a TMDS receiver 414 to communicate over TMDS link 408. In an embodiment, TMDS transmitter 412 and TMDS receiver 414 each includes a HDCP sub-module (416 and 418 in FIG. 4) for supporting HDCP security services as described above. Further, content source 402 and content sink 404 each include a DDC/E-DDC transceiver (430 and 432 in FIG. 5) to communicate over DDC/E-DDC link 410 of distribution system 406.

Additionally, content source 402 includes a controller 420 that interfaces with source DDC/E-DDC transceiver 430, and content sink 404 includes an EDID/E-EDID (Extended Display Identification Data/Enhanced EDID) memory cache 422 accessible by sink DDC/E-DDC transceiver 432. In an embodiment, the memory cache is a Read-Only Memory (ROM), and the EDID/E-EDID ROM 422 stores an EDID/E-EDID structure that describes the display capabilities of content sink 404.

In system 400, content data 424 is generated or received at content source 402 and is forwarded to TMDS transmitter 412 for transmission to content sink 404. TMDS transmitter 412 performs HDCP encryption on the content data and converts the encrypted data into TMDS format. Subsequently, TMDS transmitter 412 transfers the data to content sink 404 over TMDS link 408. Content sink 404 receives the encrypted TMDS formatted data using TMDS receiver 414, decodes the data, and performs HDCP decryption to retrieve content data 424. Prior to content transfer over TMDS link 408, (source and sink) DDC/E-DDC transceivers 430 and 432 communicate over DDC/E-DDC link 410 to exchange capabilities information, allowing the selection of the most appropriate content format for use over TMDS link 408. This includes controller 420 at content source 402 initiating a query/response exchange, as described above with respect to FIG. 2, to retrieve the display capabilities of content sink 404, stored in EDID/E-EDID memory cache 422 of content sink 404. Note that this query/response exchange is possible given that DDC/E-DDC link 410 is bidirectional. Content source 402 may then select the most appropriate format for content delivered to content sink 404 according to its own capabilities and the retrieved display capabilities.

FIG. 5 illustrates a wireless high-definition content delivery system 500 in accordance with an embodiment of the present invention. System 500 may be used to replace wired system 400 of FIG. 4. System 500 replaces wired HDMI/DVI cable 406 with a wireless distribution system 502 that includes a unidirectional content link 504 and a bidirectional configuration and control link 506. Content link 504 is such that it supports high-definition content transfer with substantially equal performance to an HDMI/DVI cable. Further embodiments of wireless content delivery systems are also described in commonly owned U.S. patent application Ser. No. 11/216,173, filed Sep. 1, 2005, entitled “System, Method and Apparatus for Wirelessly Providing a Display Data Channel Between a Generalized Content Source and a Generalized Content Sink,” which is incorporated herein by reference.

To enable the wireless solution of system 500, content source 516 and content sink 522 are respectively equipped with a source wireless media adapter 518 and a sink wireless media adapter 520. Wireless media adapter 518 includes a wireless transmitter 508 that generates signals suitable for propagation over content link 504 to wireless receiver 510 in sink wireless media adapter 520. Further, wireless media adapter 518 includes a wireless transceiver 512 and wireless media adapter 520 includes a wireless transceiver 514 for communicating over bidirectional configuration and control link 506.

In some aspects of operation, wireless system 500 is similar to wired system 400 of FIG. 4. One difference lies in the additional need to convert encrypted TMDS formatted content, generated by TMDS transmitter 412 at content source 516, into signals that can be wirelessly transmitted by wireless transmitter 508 of content source 516. This, for example, includes modulating the encrypted digital content to generate corresponding analog waveforms to transmit over wireless content link 504. Correspondingly, at content sink 522, the transmitted wireless signals are demodulated by wireless receiver 510 to retrieve the encrypted TDMS formatted content. A similar process of RF modulation/demodulation is additionally needed for communicating over wireless configuration and control link 506.

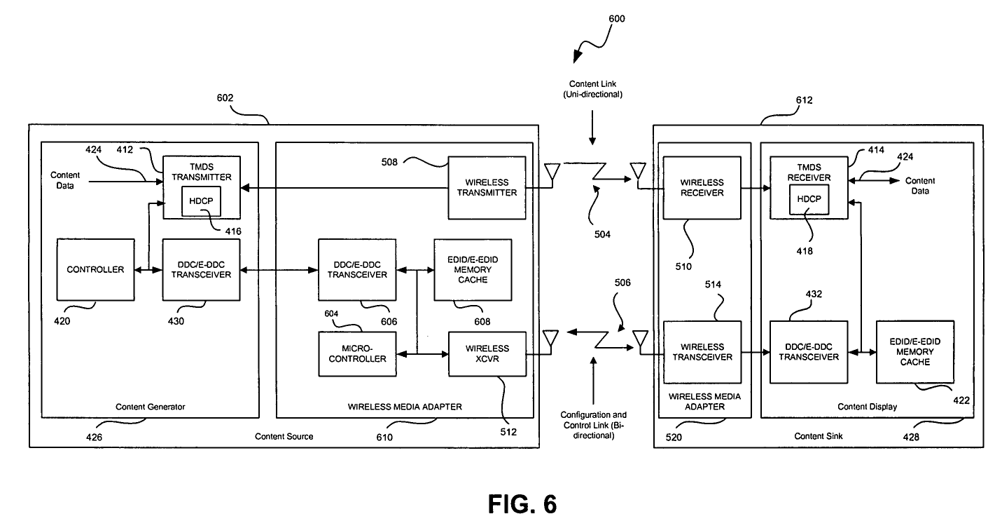

FIG. 6 illustrates one embodiment 600 of wireless system 500 of FIG. 5 according to the present invention.

In embodiment 600, content source 602 includes a wireless media adapter 610, which includes a wireless transceiver 512, a micro-controller 604, an EDID/E-EDID cache memory (such as, but not limited to, a read/write memory, RAM, or flash memory) 608, and a DDC/E-DDC transceiver 606. Wireless media adapter 610 interfaces using DDC/E-DDC transceiver 606 with a controller 420 contained within content generator 426 of content source 602. Wireless media adapter 610 uses wireless transceiver 512 to interface over wireless configuration and control link 506 with wireless transceiver 514 in content sink 612.

Other aspects of the system of FIG. 6 are substantially similar to those of system 500, described above.

According to an embodiment of the system of FIG. 6, controller 420 of content source 602 initiates a query/response exchange, as described above with respect to FIG. 2, to retrieve the display capabilities of content sink 612. The display capabilities of content sink 612 are accordingly transmitted over wireless configuration and control link 506 in the form of an EDID/E-EDID structure. The transmitted EDID/E-EDID structure is received by wireless transceiver 512 of content source 602 and forwarded to micro-controller 604 of wireless media adapter 610. In one embodiment, micro-controller 604 updates EDID/E-EDID cache memory 608 with the received EDID/E-EDID structure. In another embodiment, micro-controller 604 modifies the received EDID/E-EDID structure based on knowledge of the capabilities of content link 504. Micro-controller 604 then updates EDID/E-EDID cache memory 608 with the modified EDID/E-EDID structure. In both embodiments, after updating the EDID/E-EDID cache memory 608, micro-controller asserts a signal to controller 420 to read EDID/E-EDID cache memory 608.

Accordingly, by controlling the timing at which this signal is asserted to controller 420, micro-controller 604 of wireless media adapter 610 controls which EDID/E-EDID structure is read by controller 420, and, as a result, directly influences the format chosen for use in content delivery that follows. Using this functionality, a plurality of update methods (static, periodic, etc.) for display and/or transmission capabilities can be implemented, and subsequently, a plurality of format control methods for content delivery can be enabled.

Note that embodiment 600 allows for display capabilities retrieved from content sink 612 to be cached at content source 602, thereby reducing the initialization/re-initialization time of content delivery. Note, however, an alternative embodiment could avoid the use of the EDID/E-EDID memory cache 608 if microcontroller 604 passes the EDID/E-EDID structure, optionally modified according to the display capabilities, directly to controller 430 via DDC/E-DDC transceivers 606 and 430.

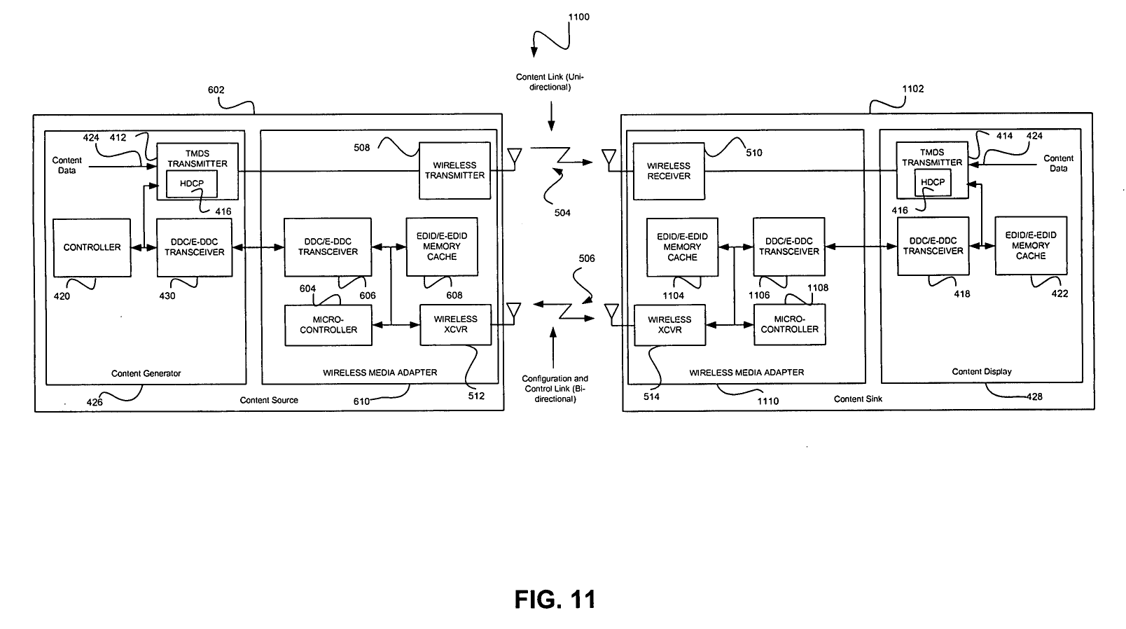

FIG. 11 illustrates an alternative embodiment 1100 of wireless system 500 of FIG. 5 according to the present invention. Embodiment 1100 benefits from the advantages described above with respect to embodiment 600. In addition, embodiment 1100 enables the content sink to directly influence the content delivery format by using information regarding the content link capabilities.

In embodiment 1100, content sink 1102 includes a wireless media adapter 1110, which includes a wireless transceiver 514, a micro-controller 1108, an EDID/E-EDID cache memory (such as, but not limited to, a read/write memory, RAM, or flash memory) 1104, and a DDC/E-DDC transceiver 1106. Wireless media adapter 1110 interfaces using DDC/E-DDC transceiver 1106 with an EDID/E-EDID memory cache 422 contained within content display 428 of content sink 1102. Wireless media adapter 1110 also interfaces using wireless transceiver 514 with content source 602 over wireless configuration and control link 506.

Other aspects of the system of FIG. 11 are substantially similar to those of system 600, described above.

According to an embodiment of the system of FIG. 11, controller 420 of content source 602 initiates a query/response exchange, as described above with respect to FIG. 2, to retrieve the display capabilities of content sink 1102. Micro-controller 1108 in wireless media adapter 1110 reads, via DDC/E-DDC transceiver 1106 communicating with content sink DDC/E-DDC transceiver 418, the EDID/E-EDID structure from the sink EDID/E-EDID memory cache 422. Micro-controller 1108 then stores this EDID/E-EDID structure in EDID/E-EDID memory cache 1104. Optionally, microcontroller 1108 then modifies the cached EDID/E-EDID structure to correct any errors in the read EDID/E-EDID structure and/or to reflect the content distribution system's capabilities. Wireless media adapter 1110 then propagates the EDID/E-EDID structure to the wireless media adapter 610 in content source 602 using configuration and control link 506.

Note that an alternative embodiment could avoid the use of EDID/E-EDID memory cache 1104 if microcontroller 1108 passes the EDID/E-EDID structure, optionally modified according to the display capabilities, directly to the content source 602.

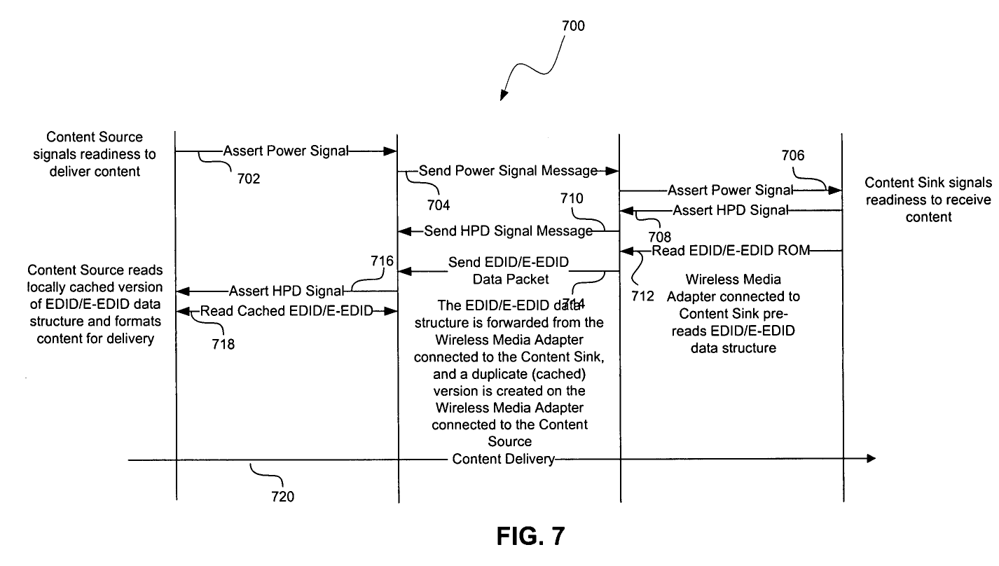

FIG. 7 is a diagram that illustrates a process 700 for statically controlling the format used for content delivery in system embodiment 600 of FIG. 6.

Process 700 begins with content source 602 signaling its readiness to deliver content by asserting a power signal to content sink 612. This is achieved by controller 420 of content source 602 asserting, in step 702, a power signal to micro-controller 604 of wireless media adapter 610 (through DDC/E-DDC transceivers 430 and 606), which in turn forwards, in step 704, the power signal to content sink 612 over wireless configuration and control link 506. Wireless transceiver 514 of content sink 612 receives the power signal and forwards, in step 706, the power signal to the appropriate controller (not shown in FIG. 6) of content sink 612.

In response to the power signal from content source 602, content sink 612 asserts, in step 708, a HPD (Hot Plug Detect) signal, which is transmitted, in step 710, over wireless configuration and control link 506 to content source 602 and forwarded to micro-controller 604 of wireless media adapter 610 at content source 602. Micro-controller 604 controls when to assert this HPD signal to controller 420 of content source 602, thereby determining which EDID/E-EDID structure controller 420 reads.

In process 700, micro-controller 604 does not assert the HPD signal to controller 420 until after an EDID/E-EDID structure is received from content sink 612, the structure is optionally modified based on the content distribution system capabilities, and the optionally modified structure is cached in EDID/E-EDID cache memory 608 of wireless media adapter 610. Accordingly, the EDID/E-EDID structure is read, in step 712, from EDID/E-EDID memory cache 422 of content sink 612 (following a query/response exchange), transmitted, in step 714, over wireless configuration and control link 506 in an EDID/E-EDID control packet, and cached by micro-controller 604 in EDID/E-EDID cache memory 608, before micro-controller 604 asserts, in step 716, the HPD signal to controller 420.

When micro-controller 604 asserts, in step 716, the HPD signal to controller 420, controller 420 performs a read (through DDC/E-DDC transceivers 430 and 606) of EDID/E-EDID cache memory 608 of wireless media adapter 610 to retrieve the cached EDID/E-EDID structure. Controller 420 then proceeds to format content according to its capabilities and the display capabilities set within the read EDID/E-EDID structure.

Subsequently, content delivery between content source 602 and content sink 612 occurs, for the duration of content delivery in step 720, according to the source capabilities and capabilities learned during the initial read of the cached EDID/E-EDID structure. Accordingly, process 700 represents a static approach for content delivery format control.

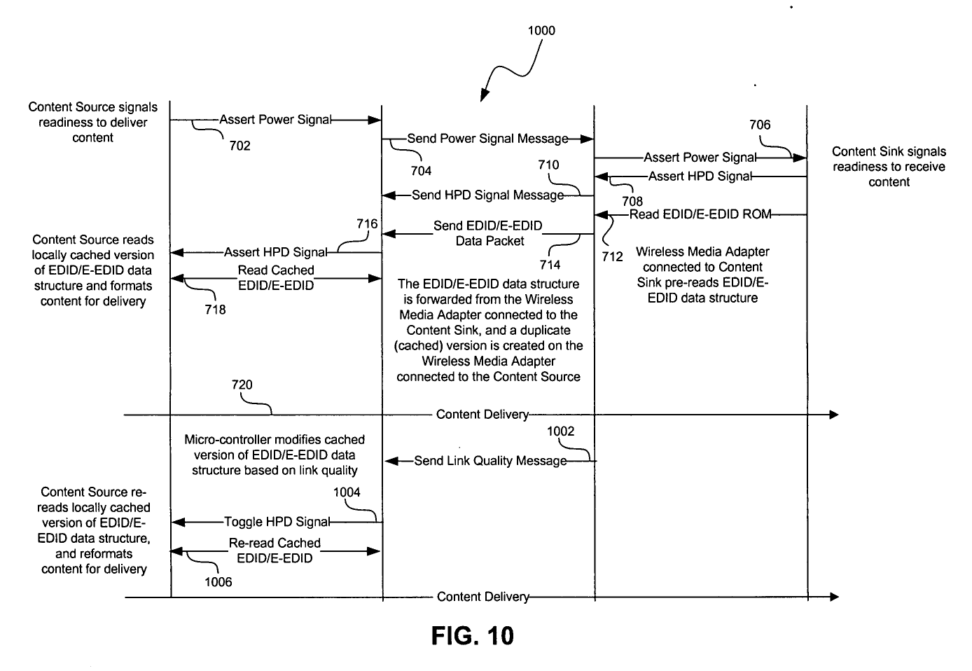

FIG. 10 is a diagram that illustrates a process 1000 for dynamically controlling the format used for content delivery in embodiment 600 of FIG. 6.

Similar to process 700, process 1000 includes initialization exchanges between content source 602 and content sink 612, including asserting a power signal from content source 602 to content sink 612 in steps 702, 704, and 706, asserting a HPD signal from content sink 612 to content source 602 in steps 708 and 710, caching the EDID/E-EDID structure of content sink 612 at content source 602, and reading this cached structure, in step 716, at a time controlled by micro-controller 604 of content source 602.

Following initialization, content source 602 formats content according to its own capabilities and the display capabilities of content sink 612, included in the EDID/E-EDID structure. This establishes an initial format for content delivery between content source 602 and content sink 612.

Subsequently, for the duration of content delivery, periodic or event-based exchanges are performed between content source 602 and content sink 612 to determine any changes in the transmission capabilities/quality of the content distribution system. In an embodiment, the exchanges include transmission capabilities/quality queries issued by content source 602 and corresponding transmission capabilities/quality responses by content sink 612.

In process 1000, these exchanges consist of unsolicited link quality messages transmitted from content sink 612 to content source 602, as illustrated in step 1002, for example.

At content source 602, micro-controller 604 processes the transmitted link quality messages and uses the results to modify the previously cached EDID/E-EDID structure, before informing content source controller 420 of the new cached EDID/E-EDID structure. In an embodiment, as illustrated in step 1004, micro-controller 604 toggles the HPD signal to assert to controller 420 the availability of a new cached EDID/E-EDID structure. Controller 420 reads the newly cached EDID/E-EDID structure from EDID/E-EDID memory 608 and proceeds to format content accordingly. In an embodiment, controller 420 determines whether to modify the content format according to any learned changes in the transmission capabilities/quality of the content distribution system. For example, content source 602 may decide to lower the content delivery data rate when a deterioration in quality of the content distribution system is detected.

The unsolicited link quality exchanges, described above, are performed for the duration of content delivery. The exchanges may be periodic or event-based. Periodic exchanges are performed at a specified period, which may be a function of the expected volatility of the content distribution system. In other words, the period is determined based on the expected rate of change in transmission capabilities/quality of the content distribution system. As will be understood by a person skilled in the art, several techniques exist for quantifying the volatility of a content distribution system. On other hand, event-based exchanges are performed in response to detected events in the content distribution system. For example, the exchanges may be performed whenever changes in transmission capabilities/quality are detected by content sink 612.

Accordingly, process 1000 allows for dynamic control of the content format used between content source 602 and content sink 612.

As would be understood by those skilled in the art, content format changes, based on updated information of the content distribution system's capabilities, can be performed entirely by wireless media adapters 610 and 520. For instance, rather than toggling the HPD signal in step 1004 to assert the availability of the new cached EDID/E-EDID structure and effectuate a content format change at content generator 426, the wireless media adapters could instead perform content format conversion transparent to content generator 426 and content display 428. In this case, the original format selected after step 718 would be used by content generator 426 and content display 428 for the duration of content delivery. However, wireless media adapters 610 and 520 would coordinate with each other to determine the most appropriate format given the content distribution system capabilities, and perform content format conversion of the original format. For example, sink wireless media adapter 520 would expect source wireless media adapter 610 to modify the content format based on link quality message 1002. As such, wireless media adapter 610 would receive data formatted by content generator 426 and perform content format conversion to the desired format for transfer over content distribution system 504. Wireless media adapter 520 would receive the data transferred over content distribution system 504 and convert it back to the format expected by content display 428. While this approach involves added wireless media adapter complexity in that content format conversion logic is required, the approach offers the advantage of highly adaptive content format changes based on updated content distribution system information.

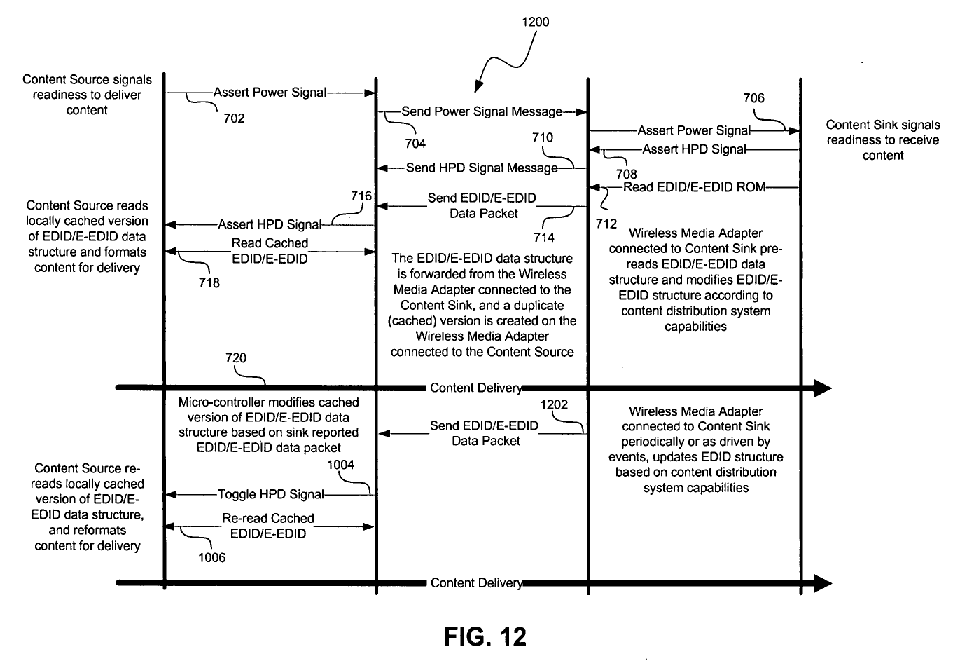

Note that format control according to embodiment 1100 can be achieved as shown in process flowchart 1200 of FIG. 12. Process 1200 is similar to process 1000, but includes the additional step of having wireless media adapter 1110 modify, according to the capabilities of the content distribution system, the EDID/E-EDID structure it reads in step 712. Wireless media adapter 1110 then passes the modified EDID/E-EDID in step 714 to wireless media adapter 610. In addition, either periodically or in response to certain events, content sink 1102 sends updates of the EDID/E-EDID data packet in step 1202 to content source 602. In one embodiment, if content sink 1102 determines that the capabilities of content distribution system 504 changed such that the content format requires a change, micro-controller 1108 modifies the cached EDID/E-EDID structure in memory cache 1104 and initiates the transfer of a EDID/E-EDID data packet in step 1202. Upon receipt of the EDID/E-EDID data packet, content source 602 modifies EDID/E-EDID memory cache 608 and toggles the HPD signal, initiating the re-reading of the cached EDID/E-EDID by the content generator 426.

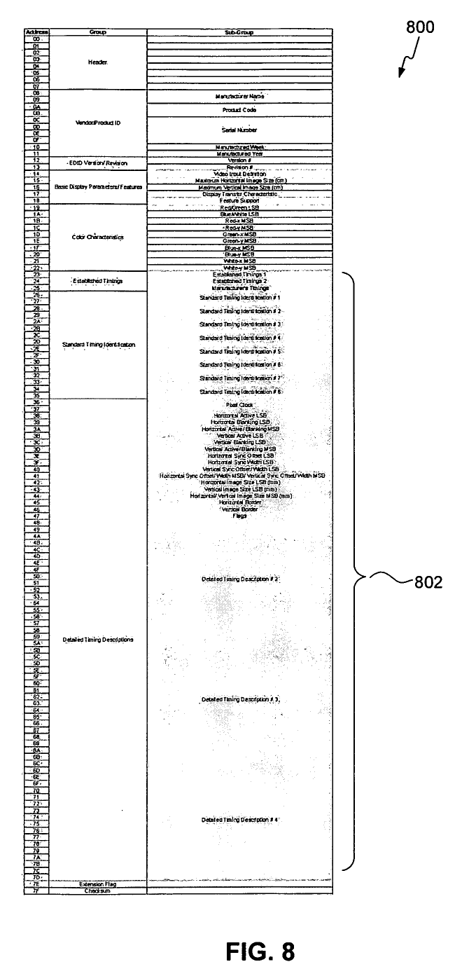

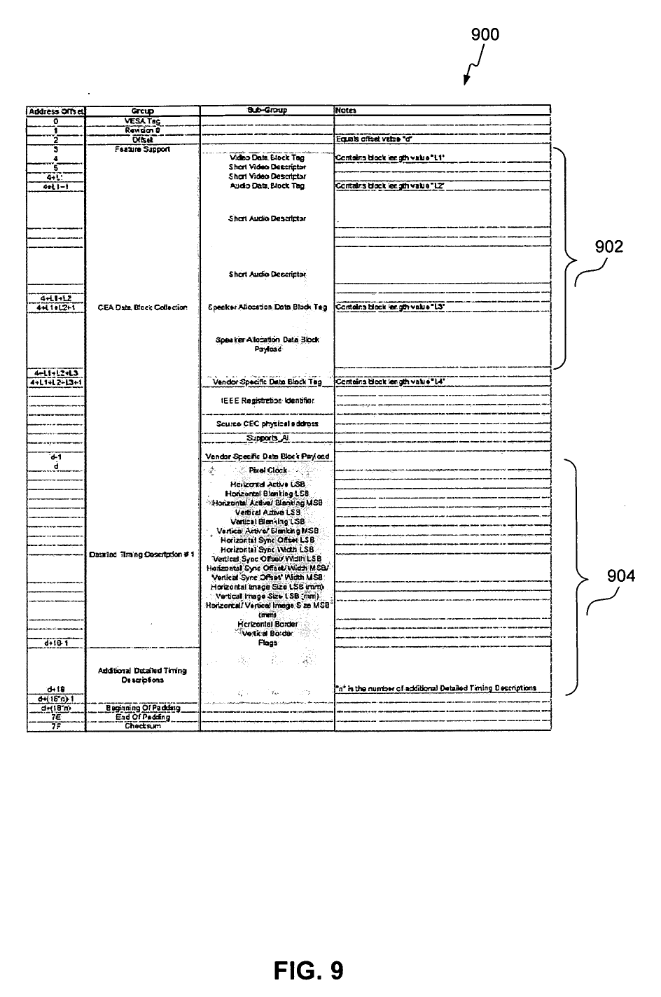

As described above, in an embodiment, the EDID/E-EDID structure of content sink 1102 may be used to relay content distribution system quality messages from content sink 1102 to content source 602. FIG. 8 illustrates a basic EDID data structure 800, which is present in a wide range of computer display equipment such as PC monitors and projectors, for example. In FIG. 8, shaded fields 802 within structure 800 denote fields which may be modified based upon transmission capabilities/quality information. FIG. 9 illustrates a Consumer Electronics Association (CEA) extension 900 to the basic EDID structure 800 of FIG. 8. CEA extension 900 is present in a wide range of consumer electronic display equipment such as HDTVs and AV receivers, for example. In particular, fields 902 and 904 belonging to the CEA Data Block Collection and the Detailed Timing Description groups are suitable for holding this information.

### D. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for controlling the format of content to be delivered from a content source to a content sink over a content distribution system, the method comprising:
(a) determining display capabilities of the content sink;
(b) determining transmission capabilities and/or a quality of the content distribution system; and
(c) adjusting the format of the content to be delivered to the content sink according to at least the determined display capabilities of the content sink and the determined transmission capabilities and/or quality of the content distribution system.

2. The method of claim 1, wherein step (c) comprises:
adjusting the format in which content is to be delivered to the content sink according to the determined display capabilities of the content sink, the determined transmission capabilities and/or quality of the content distribution system, and capabilities of the content source.

3. The method of claim 1, wherein step (a) comprises:
(i) transmitting a query to the content sink; and
(ii) receiving a response to the query from the content sink;
wherein the response includes one or more parameters associated with the display capabilities of the content sink.

4. The method of claim 3, wherein the response includes an Extended Display Identification Data (EDID)/Enhanced EDID (E-EDID) structure associated with the content sink.

5. The method of claim 4, wherein step (a) further comprises:
(iii) caching the EDID/E-EDID structure; and
(iv) asserting a Hot Plug Detect (HPD) signal to cause a controller of the content source to read the cached EDID/E-EDID structure.

6. The method of claim 1, wherein step (b) comprises:
(i) transmitting a query to the content sink; and
(ii) receiving a response to the query from the content sink;
wherein the response includes one or more parameters that characterize the transmission capabilities and/or quality of the content distribution system.

7. The method of claim 1, wherein step (b) comprises:
(i) receiving an unsolicited message from the content sink;
wherein the message includes one or more parameters that characterize the transmission capabilities and/or quality of the content distribution system.

8. The method of claim 1, wherein step (b) comprises determining a transmission capability and/or quality of one of a wired, wireless, or optical interface.

9. The method of claim 1, further comprising:
periodically repeating steps (b) and (c).

10. The method of claim 9, wherein steps (b) and (c) are repeated at a periodic rate that is based on an expected volatility of the content distribution system.

11. The method of claim 1, further comprising:
repeating steps (b) and (c) responsive to detected events in the content distribution system.

12. The method of claim 1, further comprising:
delivering the content to the content sink; and
repeating steps (b) and (c) at least once during the duration of content delivery.

13. The method of claim 1, wherein step (c) comprises:
converting the format of the content to be delivered to the content sink from a first format that is supported by a generator of the content to a second format, wherein the second format is determined based on the transmission capabilities and/or quality of the content distribution system.

14. A method for facilitating control by a content source of the format of content to be delivered from the content source to a content sink over a content distribution system, the method comprising:
(a) determining display capabilities of the content sink;
(b) determining transmission capabilities and/or a quality of the content distribution system;
(c) modifying the determined display capabilities of the content sink based on the determined transmission capabilities and/or quality of the content distribution system; and
(d) transmitting a message to the content source, wherein the message includes one or more parameters that characterize the modified display capabilities of the content sink.

15. The method of claim 14, wherein step (c) comprises modifying an Extended Display Identification Data (EDID)/Enhanced EDID (E-EDID) structure associated with the content sink based on the determined transmission capabilities and/or quality of the content distribution system, and wherein step (d) comprises transmitting a message to the content source that includes the modified EDID/E-EDID structure.

16. The method of claim 15, further comprising:
caching the EDID/E-EDID structure.

17. The method of claim 14, further comprising:
periodically repeating steps (c) and (d).

18. The method of claim 17, wherein steps (c) and (d) are repeated at a periodic rate that is based on an expected volatility of the content distribution system.

19. The method of claim 14, further comprising:
repeating steps (c) and (d) responsive to detected events in the content distribution system.

20. The method of claim 14, further comprising:
receiving content from the content source; and
repeating steps (c) and (d) at least once during the duration of content delivery.

21. A content source comprising:
a content generator configured to generate content; and
a media adapter communicatively connected to the content generator;
wherein the media adapter is configured to determine display capabilities of a content sink communicatively connected to the media adapter, to determine transmission capabilities and/or a quality of the content distribution system, and to adjust the format of the content for delivery to the content sink over the content distribution system according to at least the determined display capabilities of the content sink and the determined transmission capabilities and/or quality of the content distribution system.

22. The content source of claim 21, wherein the media adapter is configured to adjust the format of the content according to the determined display capabilities of the content sink, the determined transmission capabilities and/or quality of the content distribution system, and capabilities of the content generator.

23. The content source of claim 21, wherein the media adapter is configured to transmit a query to the content sink and receive a response to the query from the content sink, wherein the response includes one or more parameters associated with the display capabilities of the content sink.

24. The content source of claim 23, wherein the response includes an Extended Display Identification Data (EDID)/Enhanced EDID (E-EDID) structure associated with the content sink.

25. The content source of claim 24, wherein the media adapter includes a memory, and wherein the media adapter is further configured to cache the EDID/E-EDID structure in the memory and to assert a Hot Plug Detect (HPD) signal to the content generator to cause the content generator to read the cached EDID/E-EDID structure from the memory.

26. The content source of claim 21, wherein the media adapter is configured to transmit a query to the content sink and to receive a response to the query from the content sink, wherein the response includes one or more parameters that characterize the transmission capabilities and/or quality of the content distribution system.

27. The content source of claim 21, wherein the media adapter is configured to receive an unsolicited message from the content sink, wherein the message includes one or more parameters that characterize the transmission capabilities and/or quality of the content distribution system.

28. The content source of claim 21, wherein the media adapter is configured to determine a transmission capability of one of a wired or wireless interface.

29. The content source of claim 21, wherein the media adapter is further configured to repeat the steps of determining the transmission capabilities and/or quality of the content distribution system and adjusting the format of the content at a periodic rate.

30. The content source of claim 29, wherein the media adapter is further configured to repeat the steps of determining the transmission capabilities and/or quality of the content distribution system and adjusting the format of the content at a periodic rate that is based on an expected volatility of the content distribution system.

31. The content source of claim 21, wherein the media adapter is further configured to repeat the steps of determining the transmission capabilities and/or quality of the content distribution system and adjusting the format of the content responsive to a detected event in the content distribution system.

32. The content source of claim 21, wherein the media adapter is further configured to deliver the content to the content sink and to repeat the steps of determining the transmission capabilities and/or quality of the content distribution system and adjusting the format of the content at least once during the duration of content delivery.

33. The content source of claim 21, wherein the media adapter is configured to convert the format of the content from a first format that is supported by the content generator to a second format, wherein said second format is determined based on the transmission capabilities and/or quality of the content distribution system.

34. A content sink, comprising:
a content display; and
a media adapter communicatively connected to the content display;
wherein the media adapter is configured to determine display capabilities of the content display, to determine transmission capabilities and/or a quality of a content distribution system to which the content sink is communicatively connected, to modify the determined display capabilities of the content display based on the determined transmission capabilities and/or quality of the content distribution system, and to transmit a message to a content source, wherein the message includes one or more parameters that characterize the modified display capabilities of the content display.

35. The content sink of claim 34, wherein the media adapter is configured to modify an Extended Display Identification Data (EDID)/Enhanced EDID (E-EDID) structure associated with the content display based on the determined transmission capabilities and/or quality of the content distribution system, and to transmit a message to the content source that includes the modified EDID/E-EDID structure.

36. The content sink of claim 35, wherein the media adapter further comprises a memory and is further configured to cache the EDID/E-EDID structure in the memory.

37. The content sink of claim 34, wherein the media adapter is further configured to repeatedly perform the steps of modifying the determined display capabilities of the content display and transmitting a message to the content source that includes one or more parameters that characterized the modified display capabilities of the content display at a periodic rate.

38. The content sink of claim 34, wherein the periodic rate is based on an expected volatility of the content distribution system.

39. The content sink of claim 34, wherein the media adapter is further configured to repeatedly perform the steps of modifying the determined display capabilities of the content display and transmitting a message to the content source that includes one or more parameters that characterized the modified display capabilities of the content display responsive to detected events in the content distribution system.

40. The content sink of claim 34, wherein the media adapter is further configured to receiving content from the content source and to repeat the steps of modifying the determined display capabilities of the content display and transmitting a message to the content source that includes one or more parameters that characterized the modified display capabilities of the content display at least once during the duration of content delivery.

41. The content sink of claim 34, wherein the media adapter is configured to convert the format of content received from the content source from a first format to a second format, wherein the first format is determined based on the transmission capabilities and/or quality of the content distribution system.

42. The content source of claim 21, wherein the media adapter is configured to receive an unsolicited message from the content sink, wherein the message includes one or more parameters that characterize the display capabilities of the content sink.
